(19) United States
(12) Patent Application Publication
(10) Pub. No.: US 2023/0416924 A1
(43) Pub. Date: Dec. 28, 2023

(54) COMPOSITION FOR METAL OXIDE FILM FORMATION, METHOD FOR PRODUCING COMPOSITION FOR METAL OXIDE FILM FORMATION, AND METHOD FOR PRODUCING METAL OXIDE FILM USING THE COMPOSITION FOR METAL OXIDE FILM FORMATION

(71) Applicant: TOKYO OHKA KOGYO CO., LTD., Kanagawa (JP)

(72) Inventors: Kenichi YAMAUCHI, Kanagawa (JP); Kunihiro NODA, Kanagawa (JP); Michihito TAKAHASHI, Kanagawa (JP); Saeko HARAGUCHI, Kanagawa (JP); Atsushi YAMANOUCHI, Kanagawa (JP); Dai SHIOTA, Kanagawa (JP)

(21) Appl. No.: 18/334,776

(22) Filed: Jun. 14, 2023

(30) Foreign Application Priority Data
Jun. 23, 2022 (JP) 2022-101066

(51) Int. Cl. C23C 20/08

(52) U.S. Cl. CPC C23C 20/08

(57) ABSTRACT

Provided are a composition for metal oxide film formation, a method for producing the composition for metal oxide film formation, and a method for producing a metal oxide film using the composition for metal oxide film formation, which allow for a decrease in amount of residual metals after washing.

The composition for metal oxide film formation according to an embodiment of the invention contains metal oxide nanoparticles, a capping agent, a polycarboxylic acid compound, and a solvent, wherein the metal oxide nanoparticles have a size of 5 nm or less; the capping agent includes at least one selected from the group consisting of an alkoxysilane, a phenol, an alcohol, a carboxylic acid, and a carboxylic acid halide; at least one of molecular chain(s) linking any two carboxy groups in the polycarboxylic acid compound has a side chain optionally having a heteroatom, and the side chain has an alkyl group; and in the solid content of the composition for metal oxide film formation, the ratio of the mass of inorganic matter is 25% by mass or more.

This application is based on and claims the benefit of priority from Japanese Patent Application No. 2022-101066, filed on 23 Jun. 2022, the content of which is incorporated herein by reference.

### BACKGROUND OF THE INVENTION

### Field of the Invention

The present invention relates to a composition for metal oxide film formation, a method for producing the composition for metal oxide film formation, and a method for producing a metal oxide film using the composition for metal oxide film formation.

### Related Art

In etching processing for semiconductor device production, etc., a resist material such as a photoresist or an electron beam resist is generally applied to the surface of a substrate to be etched, and the substrate is etched using, as an etching mask, a resist film having a pattern formed via a lithographic technique, in order to form a predetermined pattern on the substrate to be etched.

In this regard, the resist film may fail to sufficiently work as the etching mask depending on etching rates on the substrate to be etched, due to the etching selectivity of the resist film with respect to the substrate to be etched. Thus, for the etching of such a substrate, an etching mask called a hard mask is provided on the substrate to maintain high etching selectivity of the etching mask with respect to the substrate to be etched. Examples of known hard masks include a hard mask which contains a metal oxide film containing metal oxide nanoparticles such as zirconium oxide nanoparticles (see Patent Document 1).
Patent Document 1: Japanese Unexamined Patent Application (Translation of PCT Application), Publication No. 2020-503409

### SUMMARY OF THE INVENTION

Conventional metal oxide films containing metal oxide nanoparticles are formed, for example, by applying a composition containing the metal oxide nanoparticles to the surface of a substrate using a spinner, followed by heating the resultant coating film. This composition may adhere to an end face (edge) of the substrate, and/or go around the substrate to the back face thereof and adhere thereto, and therefore edge-rinsing, back-rinsing, and/or the like is performed to remove the composition therefrom. In the studies by the present inventors, it was found for conventional compositions containing metal oxide nanoparticles that the edge-rinsing and/or the back-rinsing did not fully remove the metal oxide nanoparticles, and causes contamination of apparatuses.

The present invention was made in view of such conventional circumstances, and an object of the present invention is to provide a composition for metal oxide film formation, a method for producing the composition for metal oxide film formation, and a method for producing a metal oxide film using the composition for metal oxide film formation, which allow for a decrease in amount of residual metals after washing.

The present inventors have conducted intensive research to solve the above problems. In consequence, the present inventors have found that the problems can be solved by a composition for metal oxide film formation, the composition containing metal oxide nanoparticles of a specific size, a specific capping agent, and a solvent, in which in the solid content of the composition for metal oxide film formation, the ratio of the mass of inorganic matter to the sum of the mass of the inorganic matter and the mass of organic matter is 25% by mass or more, and in which the composition for metal oxide film formation contains a specific polycarboxylic acid compound, thus completing the present invention. Specifically, the present invention provides the following.

A first aspect of the present invention provides a composition for metal oxide film formation, comprising metal oxide nanoparticles, a capping agent, a polycarboxylic acid compound, and a solvent, wherein
the polycarboxylic acid compound is comprised as the capping agent, or separate from the capping agent,
the metal oxide nanoparticles have a size of 5 nm or less,
the capping agent comprises at least one selected from the group consisting of an alkoxysilane, a phenol, an alcohol, a carboxylic acid, and a carboxylic acid halide,
at least one of molecular chain(s) linking any two carboxy groups in the polycarboxylic acid compound has a side chain optionally having a heteroatom, and the side chain has an alkyl group, and
in the solid content of the composition for metal oxide film formation, the ratio of the mass of inorganic matter to the sum of the mass of the inorganic matter and the mass of organic matter is 25% by mass or more.

A second aspect of the present invention provides the composition for metal oxide film formation according to the first aspect, wherein a metal comprised in the metal oxide nanoparticles is at least one selected from the group consisting of zinc, yttrium, hafnium, zirconium, lanthanum, cerium, neodymium, gadolinium, holmium, lutetium, tantalum, titanium, silicon, aluminum, antimony, tin, indium, tungsten, copper, vanadium, chromium, niobium, molybdenum, ruthenium, rhodium, rhenium, iridium, germanium, gallium, thallium, scandium, and magnesium.

A third aspect of the present invention provides the composition for metal oxide film formation according to the first or second aspect, wherein the polycarboxylic acid compound is succinic acid having a side chain, and the side chain optionally has a heteroatom and has an alkyl group.

A fourth aspect of the present invention provides the composition for metal oxide film formation according to the third aspect, wherein the succinic acid is spiculisporic acid.

A fifth aspect of the present invention provides a method for producing the composition for metal oxide film formation according to any one of the first to fourth aspects, the method comprising:
mixing a first dispersion comprising the metal oxide nanoparticles, the capping agent, and the solvent with a polycarboxylic acid compound solution comprising the polycarboxylic acid compound and the solvent, and the solvent, or
mixing a second dispersion comprising the metal oxide nanoparticles, the polycarboxylic acid compound, and the solvent with the solvent.

A sixth aspect of the present invention provides a method for producing a metal oxide film, the method comprising:
forming a coating film comprising the composition for metal oxide film formation according to any one of the first to fourth aspects, and
heating the coating film.

A seventh aspect of the present invention provides the method for producing the metal oxide film according to the sixth aspect, further comprising performing at least one of edge-rinsing or back-rinsing.

An eighth aspect of the present invention provides the method according to the sixth or seventh aspect, wherein the metal oxide film is a sacrificial film or a permanent film.

The present invention can provide a composition for metal oxide film formation, a method for producing the composition for metal oxide film formation, and a method for producing a metal oxide film using the composition for metal oxide film formation, which allow for a decrease in amount of residual metals after washing.

### DETAILED DESCRIPTION OF THE INVENTION

Composition for Metal Oxide Film Formation

A composition for metal oxide film formation according to an embodiment of the invention contains metal oxide nanoparticles, a capping agent, a polycarboxylic acid compound, and a solvent. The composition for metal oxide film formation according to the embodiment of the invention allows for a decrease in amount of residual metals after washing.

The mechanism of the achievement of such an effect is not entirely elucidated, but the present inventors presume as follows.

Specifically, the inventors presume that: at least one of molecular chain(s) linking any two carboxy groups in the polycarboxylic acid compound described above has a side chain optionally having a heteroatom, and the side chain has an alkyl group, and hence, in the case of the polycarboxylic acid compound being contained separate from the capping agent, the compound is adsorbed onto the substrate before the metal oxide nanoparticles coated with the capping agent, and the alkyl group-bearing side chain of the compound is arranged perpendicularly to the substrate; and this suppresses the adsorption of the metal oxide nanoparticles coated with the capping agent to the substrate, leading to the facilitation of the removal of the metal oxide nanoparticles in the washing step.

The inventors further presume that when the polycarboxylic acid compound is contained as the capping agent, the adsorption of the metal oxide nanoparticles to the substrate is suppressed due to the alkyl group-bearing side chain of the polycarboxylic acid compound coating the metal oxide nanoparticles, leading to the facilitation of the removal of the metal oxide nanoparticles in the washing step.

In the solid content of the composition for metal oxide film formation, the ratio of the mass of inorganic matter to the sum of the mass of the inorganic matter and the mass of organic matter is 25% by mass or more, preferably 30% by mass or more, and more preferably 40% by mass or more. When the ratio is within the range described above, a high ratio of the mass of the inorganic matter can be achieved, and as a result, the resultant metal oxide film is likely to be inhibited from volume shrinkage upon heating at a low temperature of 400° C. or lower. The upper limit of the ratio is not particularly limited, and may be 90% by mass, 80% by mass, or 75% by mass.

Metal Oxide Nanoparticles

The composition for metal oxide film formation according to the embodiment of the invention contains metal oxide nanoparticles. It should be noted that the metal oxide nanoparticles consist of metal oxides, and does not include the capping agent. A metal included in the metal oxide nanoparticles is not particularly limited, and examples thereof include zinc, yttrium, hafnium, zirconium, lanthanum, cerium, neodymium, gadolinium, holmium, lutetium, tantalum, titanium, silicon, aluminum, antimony, tin, indium, tungsten, copper, vanadium, chromium, niobium, molybdenum, ruthenium, rhodium, rhenium, iridium, germanium, gallium, thallium, scandium, and magnesium. Zinc, yttrium, hafnium, and zirconium is preferable, and zirconium is more preferable from the viewpoint of film-forming properties, stability, etc. The metals may be used either singly or in a combination of two or more types thereof.

The metal oxide nanoparticles are preferably in the form of a metal oxide nanocluster. When the composition for metal oxide film formation according to the embodiment of the invention contains the metal oxide nanocluster together with the capping agent, the resultant metal oxide film is likely to be inhibited from volume shrinkage upon heating at a low temperature of 400° C. or lower. The term “metal oxide nanocluster” as used herein means a metal oxide aggregate, which includes a plurality of planes formed by the metal oxides.

Diffraction peaks corresponding to the planes described above are detected by X-ray diffraction measurement on the metal oxide nanocluster. The metal oxide nanocluster may include crystals, crystallites, or amorphous matter. X-ray diffraction patterns of the metal oxide nanocluster show peaks ascribed to the planes (crystal planes) of the metal atoms, broad protrusions, or broad halo patterns are found, depending on the components included in the metal oxide nanocluster. When none of the peaks, the broad protrusions or the broad halo patterns are found in an X-ray diffraction pattern of certain sample, it shall be determined herein that the sample contains no metal oxide nanocluster.

The metal oxide nanoparticles have a size of 5 nm or less, preferably 4 nm or less, and more preferably 3 nm or less. The lower limit of the size of the metal oxide nanoparticles is not particularly limited, and may be, for example, 0.5 nm or more, 1 nm or more, or 2 nm or more. When the size of the metal oxide nanoparticles is greater than 5 nm, the resultant metal oxide film is less likely to be inhibited from volume shrinkage upon heating at a low temperature of 400° C. or lower, and hence it is considered that the intra-plane uniformity of the metal oxide film tends to be impaired in main baking at a higher temperature of 450° C. Consequently, the use of the metal oxide film obtained after the main baking as a hard mask in dry etching is likely to render uniform dry etching difficult. The term “size” of the metal oxide nanoparticles as used herein means a value calculated according to the Halder-Wagner method from the half-width of a scattering peak in a spectrum obtained in X-ray scattering intensity distribution measurement.

The amount of the metal oxide nanoparticles used is not particularly limited, and is, for example, 45 to 75% by mass, and preferably 50 to 72% by mass based on the total mass of the components other than the solvent in the composition for metal oxide film formation. When the amount of the metal oxide nanoparticles used is within the range described above, the resultant metal oxide film is likely to be inhibited from volume shrinkage upon heating at a low temperature of 400° C. or lower.

Capping Agent

It is presumed that in the composition for metal oxide film formation according to the embodiment of the invention, a part or all of the metal oxide nanoparticles are coated with the capping agent. The capping agent includes at least one selected from the group consisting of an alkoxysilane, a phenol, an alcohol, a carboxylic acid, and a carboxylic acid halide. Since the composition for metal oxide film formation according to the embodiment of the invention contains the capping agent together with the metal oxide nanoparticles, the resultant metal oxide film is likely to be inhibited from volume shrinkage upon heating at a low temperature of 400° C. or lower.

Specific examples of the capping agent include: alkoxysilanes such as n-propyltrimethoxysilane, n-propyltriethoxysilane, n-octyltrimethoxysilane, n-octyltriethoxysilane, n-dodecyltrimethoxysilane, n-dodecyltriethoxysilane, n-hexadecyltrimethoxysilane, n-hexadecyltriethoxysilane, n-octadecyltrimethoxysilane, n-octadecyltriethoxysilane, phenyltrimethoxysilane, phenyltriethoxysilane, phenethylphenyltrimethoxysilane, phenethylethyltriethoxysilane, 3-{2-methoxy[poly(ethyleneoxy)]}propyltrimethoxysilane, 3-{2-methoxy [poly(ethyleneoxy)]}propyltriethoxysilane, 3-{2-methoxy [tri(ethyleneoxy)]}propyltrimethoxysilane, 3-{2-methoxy[tri(ethyleneoxy)]}propyltriethoxysilane, vinyltrimethoxysilane, vinyltriethoxysilane, allyltrimethoxysilane, allyltriethoxysilane, 1-hexenyltrimethoxysilane, 1-hexenyltriethoxysilane, 1-octenyltrimethoxysilane, 1-octenyltriethoxysilane, 3-aminopropyltrimethoxysilane, 3-aminopropyltriethoxysilane, 3-mercaptopropyltrimethoxysilane, 3-mercaptopropyltriethoxysilane, 3-acryloyloxypropyltrimethoxysilane, 3-acryloylpropyltriethoxysilane, 3-methacryloyloxypropyltrimethoxysilane, 3-methacryloyloxypropyltriethoxysilane, 3-isocyanatopropyltrimethoxysilane, 3-isocyanatopropyltriethoxysilane, 3-glycidoxypropyltrimethoxysilane, and 3-glycidoxypropyltriethoxysilane; phenols or alcohols such as ethanol, n-propanol, isopropanol, n-butanol, n-heptanol, n-hexanol, n-octanol, oleyl alcohol, n-dodecyl alcohol, n-octadecanol, benzyl alcohol, phenol, and triethylene glycol monomethyl ether; carboxylic acids such as octanoic acid, acetic acid, propionic acid, 2-[2-(methoxyethoxy)ethoxy]acetic acid, oleic acid, lauric acid, benzoic acid, 2-acryloyloxyethylsuccinic acid, 2-acryloyloxyethylphthalic acid, 2-methacryloyloxyethylsuccinic acid, 2-methacryloyloxyethylphthalic acid, and spiculisporic acid; and carboxylic acid halides of these carboxylic acids, such as acid chlorides of these carboxylic acids. The capping agent preferably includes a compound mentioned above as phenols, alcohols, or carboxylic acids.

The amount of the capping agent used is not particularly limited, and is, for example, 10 to 35% by mass, and preferably 18 to 28% by mass based on the total mass of the components other than the solvent in the composition for metal oxide film formation. When the amount of the capping agent used is within the range described above, the ratio of the mass of the organic matter is not excessively high, and consequently the resultant metal oxide film is likely to be inhibited from volume shrinkage upon heating at a low temperature of 400° C. or lower.

In the solid content of the composition for metal oxide film formation, the ratio of the mass of the metal oxide nanoparticles to the total mass of the metal oxide nanoparticles and the capping agent is, for example, 50% by mass or more, preferably 55% by mass or more, more preferably 60% by mass or more, and even more preferably 65% by mass or more. The upper limit of the mass ratio is, for example, 95% by mass or less, and preferably 90% by mass or less.

Polycarboxylic Acid Compound

The composition for metal oxide film formation according to the embodiment of the invention contains the polycarboxylic acid compound. At least one of molecular chain(s) linking any two carboxy groups in the polycarboxylic acid compound has a side chain optionally having a heteroatom, and the side chain has an alkyl group. The incorporation of such a polycarboxylic acid compound allows for a decrease in amount of residual metals after washing.

The polycarboxylic acid compound is contained as the capping agent, or separate from the capping agent. It is presumed that when the polycarboxylic acid compound is contained as the capping agent, a part or all of the metal oxide nanoparticles in the composition for metal oxide film formation according to the embodiment of the invention are coated with the polycarboxylic acid compound. Incidentally, the phrase “contained separate from the capping agent” as used herein means that both the capping agent (except for the polycarboxylic acid compound) and the polycarboxylic acid compound are contained in the composition for metal oxide film formation.

Examples of the heteroatom include an oxygen atom, a nitrogen atom and a sulfur atom. Examples of the side chain optionally having the heteroatom and having the alkyl group include a group represented by —X—R. X represents a single bond, or a divalent group selected from the group consisting of —O—, —CO—, —COO—, —OCO—, —OCOO—, —NH—, —CONH—, —NHCO—, —NHCONH—, —S—, —SO—, and —SO₂—. R represents an alkyl group. The alkyl group in R may be linear, branched or cyclic, and linear alkyl groups are preferable. Additionally, the alkyl group in R may be an alkyl group having 1 or more and 15 or less carbon atoms (preferably 6 or more and 14 or less carbon atoms), and examples thereof include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, etc.

The number of carboxy groups included in the polycarboxylic acid compound is not particularly limited, but must be 2 or more, and is preferably 2 or 3, and more preferably 2.

The polycarboxylic acid compound is preferably an aliphatic dicarboxylic acid having a side chain, the side chain optionally having a heteroatom and having an alkyl group. Examples of the aliphatic dicarboxylic acid include malonic acid, succinic acid, glutaric acid, adipic acid, pimelic acid, etc., and among these, succinic acid, glutaric acid, and adipic acid are preferable, and succinic acid is more preferable.

Examples of succinic acid having a side chain, the side chain optionally having a heteroatom and having an alkyl group, include 2-methylsuccinic acid, 2-ethylsuccinic acid, 2-propylsuccinic acid, 2-butylsuccinic acid, 2-pentylsuccinic acid, 2-hexylsuccinic acid, 2-heptylsuccinic acid, 2-octylsuccinic acid, 2-nonylsuccinic acid, 2-decylsuccinic acid, etc.; 2,3-dimethylsuccinic acid, 2,3-diethylsuccinic acid, 2,3-dipropylsuccinic acid, 2,3-dibutylsuccinic acid, 2,3-dipentylsuccinic acid, 2,3-dihexylsuccinic acid, 2,3-diheptylsuccinic acid, 2,3-dioctylsuccinic acid, 2,3-dinonylsuccinic acid, 2,3-didecylsuccinic acid, etc.; spiculisporic acid, etc. Among these, 2-octylsuccinic acid and spiculisporic acid are preferable.

The amount of the polycarboxylic acid compound used is not particularly limited, and is, for example, 1 to 30% by mass, and preferably 5 to 20% by mass based on the total mass of the components other than the solvent in the composition for metal oxide film formation. When the amount of the polycarboxylic acid compound used is within the range described above, the decrease in amount of residual metals after washing is likely to be achieved.

In the solid content of the composition for metal oxide film formation, the ratio of the mass of the metal oxide nanoparticles to the total mass of the metal oxide nanoparticles and the polycarboxylic acid compound is, for example, 50% by mass or more, preferably 55% by mass or more, more preferably 60% by mass or more, and even more preferably 65% by mass or more. The upper limit of the mass ratio is, for example, 95% by mass or less, and preferably 90% by mass or less.

Solvent

The composition for metal oxide film formation according to the embodiment of the invention contains the solvent for the purpose of adjusting the coating properties and viscosity thereof. Typically, an organic solvent is used as the solvent. The type of the organic solvent is not particularly limited so long as it can uniformly dissolve or disperse the components contained in the composition for metal oxide film formation.

Examples of suitable organic solvents which may be used as the solvent include: (poly)alkylene glycol monoalkyl ethers such as ethylene glycol monomethyl ether, ethylene glycol monoethyl ether, ethylene glycol mono-n-propyl ether, ethylene glycol mono-n-butyl ether, diethylene glycol monomethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, propylene glycol mono-n-propyl ether, propylene glycol mono-n-butyl ether, dipropylene glycol monomethyl ether, dipropylene glycol monoethyl ether, dipropylene glycol mono-n-propyl ether, dipropylene glycol mono-n-butyl ether, tripropylene glycol monomethyl ether, and tripropylene glycol monoethyl ether; (poly)alkylene glycol monoalkyl ether acetates such as ethylene glycol monomethyl ether acetate, ethylene glycol monoethyl ether acetate, diethylene glycol monomethyl ether acetate, diethylene glycol monoethyl ether acetate, propylene glycol monomethyl ether acetate, and propylene glycol monoethyl ether acetate; other ethers such as diethylene glycol dimethyl ether, diethylene glycol methyl ethyl ether, diethylene glycol diethyl ether, and tetrahydrofuran; ketones such as methyl ethyl ketone, cyclohexanone, 2-heptanone, and 3-heptanone; lactic acid alkyl esters such as methyl 2-hydroxypropionate and ethyl 2-hydroxypropionate; other esters such as ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxyacetate, ethyl hydroxyacetate, methyl 2-hydroxy-3-methylbutanoate, 3-methyl-3-methoxybutyl acetate, 3-methyl-3-methoxybutyl propionate, ethyl acetate, n-propyl acetate, isopropyl acetate, n-butyl acetate, isobutyl acetate, n-pentyl formate, isopentyl acetate, n-butyl propionate, ethyl butyrate, n-propyl butyrate, isopropyl butyrate, n-butyl butyrate, methyl pyruvate, ethyl pyruvate, n-propyl pyruvate, methyl acetoacetate, ethyl acetoacetate, and ethyl 2-oxobutanoate; aromatic hydrocarbons such as toluene and xylene; amides such as N-methylpyrrolidone, N,N-dimethylformamide, and N,N-dimethylacetamide; etc. These organic solvents may be either singly or in a combination of two or more types thereof.

The amount of the solvent used in the composition for metal oxide film formation according to the embodiment of the invention is not particularly limited. The amount of the solvent used is, for example, 30 to 99.9% by mass, and preferably 50 to 98% by mass based on the total mass of the composition for metal oxide film formation from the viewpoint of, for example, the coating properties of the composition for metal oxide film formation.

Base Material

The composition for metal oxide film formation according to the embodiment of the invention may further contain a base material for the purpose of adjusting the coating film-forming properties and coating properties thereof. One type of the base material may be used alone, and a combination of two or more types of the base material may be used. The base material is not particularly limited, and polymers such as resins described below and non-polymers such as low-molecular-weight compounds may be used.

The mass average molecular weight (hereinafter, referred to as “Mw”) of the base material is not particularly limited so long as the effects of the present invention are not inhibited, and is preferably 700 or more and 40,000 or less, more preferably 900 or more and 30,000 or less, and even more preferably 1,000 or more and 20,000 or less. When the Mw falls within the above range, the coating film-forming properties and coating properties tend to be favorable. In addition, when a polymer having an Mw of 40,000 or less or a non-polymer is used, favorable gap-filling properties tend to be achieved on a substrate having projections/depressions. It should be noted that the Mw as used herein refers to polystyrene equivalent Mw as determined by gel permeation chromatography (GPC).

Acrylic Resin (a-IV)

Resins which include a structural unit derived from (meth)acrylic acid and/or a structural unit derived from other monomer such as (meth)acrylic acid esters may be used as acrylic resin (a-IV). The (meth)acrylic acid means acrylic acid or methacrylic acid. Typically, a compound represented by the following formula (a-4-1) is preferably used as a monomer which gives the structural unit in the acrylic resin (a-IV).

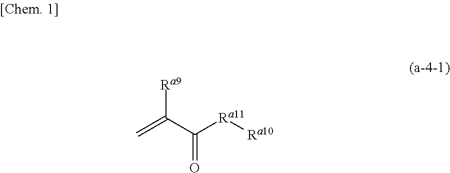

In the above formula (a-4-1), R^{a9} represents a hydrogen atom or a methyl group. R^{a10} represents a hydrogen atom or a monovalent organic group. This organic group may include therein any bond or substituent other than a hydrocarbon group, such as a heteroatom. Additionally, this organic group may be linear, branched, or cyclic. R^{a11} represents a group represented by —O— or —NR^{a12}—. R^{a12} represents a hydrogen atom, or an alkyl group having 1 or more and 6 or less carbon atoms.

The substituent other than a hydrocarbon group in the organic group in R^{a10} is not particularly limited so long as the effects of the invention are not inhibited, and examples thereof include a halogen atom, a hydroxyl group, a mercapto group, a sulfide group, a cyano group, an isocyano group, a cyanate group, an isocyanate group, a thiocyanate group, an isothiocyanate group, a silyl group, a silanol group, an alkoxy group, an alkoxycarbonyl group, a carbamoyl group, a thiocarbamoyl group, a nitro group, a nitroso group, a carboxy group, a carboxylate group, an acyl group, an acyloxy group, a sulfino group, a sulfo group, a sulfonate group, a phosphino group, a phosphinyl group, a phosphono group, a phosphonate group, a hydroxyimino group, an alkyl ether group, an alkyl thioether group, an aryl ether group, an aryl thioether group, an amino group (—NH₂, —NHR, and —NRR′, wherein R and R′ each independently represents a hydrocarbon group), etc. The hydrogen atom(s) included in the substituent may be substituted with a hydrocarbon group. In addition, the hydrocarbon group included in the substituent may be linear, branched, or cyclic.

Further, the organic group as R^{a10} may have a reactive functional group such as an acryloyloxy group, a methacryloyloxy group, an epoxy group, and an oxetanyl group. Acyl groups having an unsaturated double bond or the like, such as an acryloyloxy group and a methacryloyloxy group can be produced, for example, by reacting at least a part of epoxy groups in the acrylic resin (a-IV) including structural units having an epoxy group with an unsaturated carboxylic acid such as acrylic acid or methacrylic acid. After the reaction of at least a part of the epoxy groups with the unsaturated carboxylic acid, a group generated in the reaction may be subjected to the reaction with a polybasic acid anhydride.

Specific examples of the polybasic acid anhydride include maleic anhydride, succinic anhydride, itaconic anhydride, phthalic anhydride, tetrahydrophthalic anhydride, hexahydrophthalic anhydride, methylhexahydrophthalic anhydride, methyltetrahydrophthalic anhydride, trimellitic anhydride, pyromellitic dianhydride, benzophenonetetracarboxylic dianhydride, 3-methylhexahydrophthalic anhydride, 4-methylhexahydrophthalic anhydride, 3-ethylhexahydrophthalic anhydride, 4-ethylhexahydrophthalic anhydride, tetrahydrophthalic anhydride, 3-methyltetrahydrophthalic anhydride, 4-methyltetrahydrophthalic anhydride, 3-ethyltetrahydrophthalic anhydride, and 4-ethyltetrahydrophthalic anhydride, etc.

In addition, an unsaturated double bond can be introduced into the acrylic resin (a-IV) by reacting a compound having an epoxy group and an unsaturated double bond with the structural unit derived from an unsaturated carboxylic acid such as acrylic acid or methacrylic acid, which is included in the acrylic resin (a-IV). Glycidyl (meth)acrylate, and compounds represented by the formulas (a-4-1a) to (a-4-1o) described later, for example, may be used as the compound having an epoxy group and an unsaturated double bond.

As R^{a10}, an alkyl group, an aryl group, a cycloalkyl group, a polycycloalkyl group, a cycloalkylalkyl group, a polycycloalkylalkyl group, an aralkyl group, or a heterocyclic group is preferable; these groups may be substituted with a halogen atom, a hydroxyl group, an alkyl group, or a heterocyclic group, and these groups may have an oxygen atom bonded thereto to form an epoxy group. Further, when these groups include an alkylene moiety, the alkylene moiety may be interrupted by an ether linkage, a thioether linkage, or an ester linkage.

When the alkyl group is linear or branched, the number of carbon atoms thereof is preferably 1 or more and 20 or less, more preferably 1 or more and 15 or less, and particularly preferably 1 or more and 10 or less. Examples of suitable alkyl groups include a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an n-heptyl group, an n-octyl group, an isooctyl group, a sec-octyl group, a tert-octyl group, an n-nonyl group, an isononyl group, an n-decyl group, an isodecyl group, etc.

In the cycloalkyl group, the polycycloalkyl group, the cycloalkylalkyl group, the polycycloalkylalkyl group, and an alicyclic group-containing group other than the groups described just before, suitable examples of an alicyclic group included in these groups include: monocyclic alicyclic groups such as a cyclopentyl group and a cyclohexyl group; and polycycloalkyl groups such as an adamantyl group, a norbornyl group, an isobornyl group, a tricyclononyl group, a tricyclodecyl group, a tetracyclododecyl group, a bicyclo-[2.1.1]-hexyl group, a bicyclo-[2.2.1]-heptyl group, a bicyclo-[2.2.2]-octyl group, a bicyclo-[3.3.0]-octyl group, a bicyclo-[4.3.0]-nonyl group, and a bicyclo-[4.4.0]-decyl group.

Suitable examples of compounds represented by the formula (a4-1) and having, as R^{a10}, the cycloalkyl group, the polycycloalkyl group, the cycloalkylalkyl group, the polycycloalkylalkyl group, and the alicyclic group-containing group other than the groups described just before include compounds represented by the following formulas (a-4-1a) to (a-4-1h). Among these, the compounds represented by the following formulas (a-4-1c) to (a-4-1h) are preferable, and the compound represented by the following formula (a-4-1c) or (a-4-1d) is more preferable.

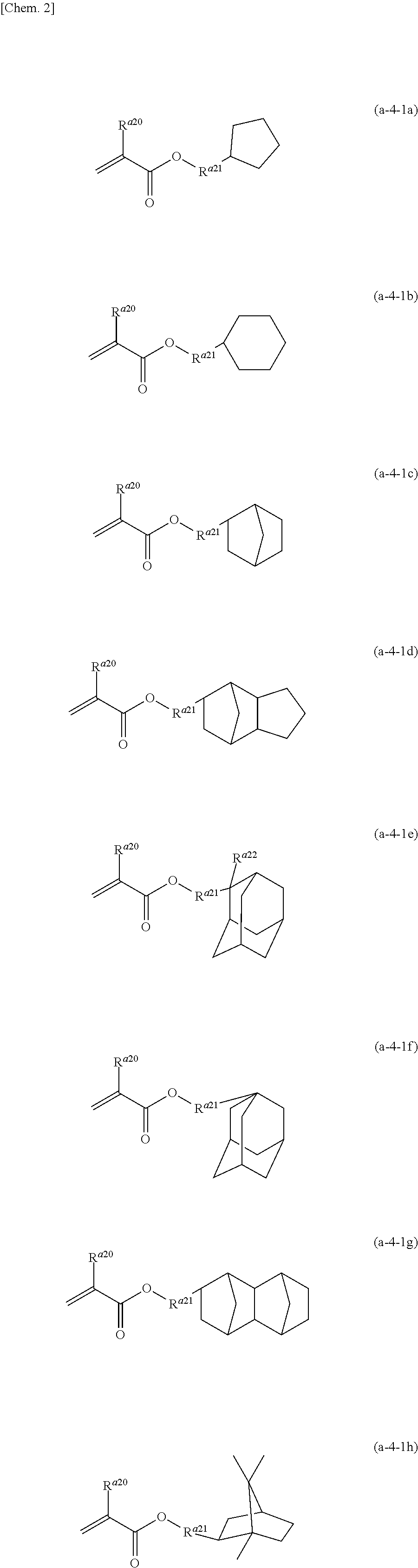

In the above formulas, R^{a20} represents a hydrogen atom or a methyl group, R^{a21} represents a single bond or a divalent aliphatic saturated hydrocarbon group having 1 or more and 6 or less carbon atoms, and R^{a22} represents a hydrogen atom or an alkyl group having 1 or more and 5 or less carbon atoms. R^{a21} preferably represents a single bond, a linear or branched alkylene group, for example, a methylene group, an ethylene group, a propylene group, a tetramethylene group, an ethylethylene group, a pentamethylene group, or a hexamethylene group. R^{a22} preferably represents, for example, a methyl group, an ethyl group.

It is preferable that an acrylic resin which includes a structural unit derived from polycycloalkyl (meth)acrylate (A-1) and/or a structural unit derived from aralkyl (meth)acrylate (A-2) is contained. When the acrylic resin includes the structural unit derived from the compound (A-1), it is preferable in view of the effects of the invention that the acrylic resin includes, for example, a structural unit derived from a compound (A-1) which is represented by any one of the above formulas (a-4-1c) to (a-4-1h), wherein R^{a21} represents a single bond.

In the case of the compound represented by the formula (a-4-1) having, as R^{a10}, a linear group having an epoxy group, specific examples of the compound represented by the formula (a-4-1) include (meth)acrylic acid epoxyalkyl esters such as glycidyl (meth)acrylate, 2-methylglycidyl (meth)acrylate, 3,4-epoxybutyl (meth)acrylate, and 6,7-epoxyheptyl (meth)acrylate.

Alternatively, the compound represented by the formula (a-4-1) may be an alicyclic epoxy group-containing (meth)acrylic acid ester. The alicyclic group constituting the alicyclic epoxy group may be monocyclic or polycyclic. Examples of the monocyclic alicyclic group include cycloalkyl groups such as a cyclopentyl group and a cyclohexyl group. Examples of the polycyclic alicyclic group include polycycloalkyls such as a norbornyl group, an isobornyl group, a tricyclononyl group, a tricyclodecyl group, and a tetracyclododecyl group.

In the case of the compound represented by the formula (a-4-1) being (meth)acrylate including an alicyclic epoxy group, specific examples thereof include compounds represented by, for example, the following formulas (a-4-1i) to (a-4-1m).

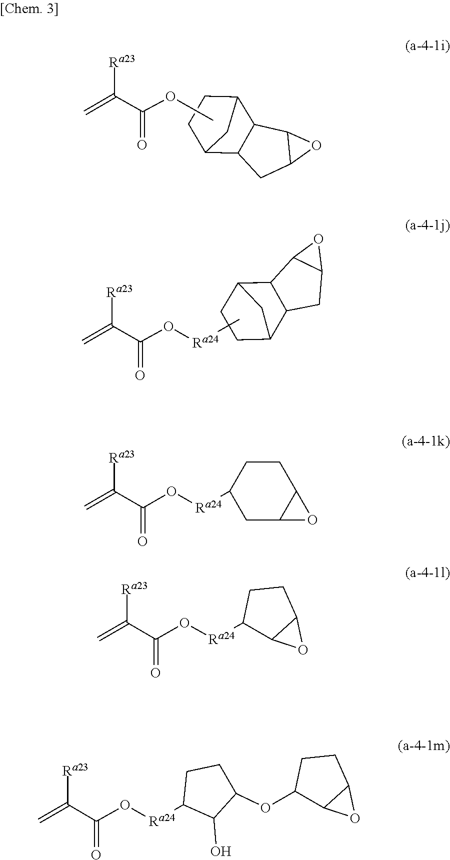

Further, other specific examples of the compound represented by the formula (a-4-1) include (meth)acrylic monomers such as (meth)acrylic acid, 2-hydroxyethyl (meth)acrylate, 2-hydroxypropyl (meth)acrylate, 2-hydroxy-3-phenoxypropyl (meth)acrylate, 2-(meth)acryloyloxyethylsuccinic acid, 2-(meth)acryloyloxyethylphthalic acid, 2-(meth)acryloyloxyethyl-2-hydroxyethylphthalic acid, mono-2-(meth)acryloyloxyethyl acid phosphate, di-2-(meth)acryloyloxyethyl acid phosphate, 2-hydroxybutyl (meth)acrylate, 2-(meth)acryloyloxyethylhexahydrophthalic acid, glycerin di(meth)acrylate, 2-hydroxy-3-phenoxypropyl (meth)acrylate, bisphenol A diglycidyl ether (meth)acrylic acid adduct, 0-phenylphenol glycidyl ether (meth)acrylate, 1,4-butanediol diglycidyl ether di(meth)acrylate, 1,6-hexanediol diglycidyl ether di(meth)acrylate, dipropylene glycol diglycidyl ether di(meth)acrylate, pentaerythritol polyglycidyl ether (meth)acrylate, 1,3-propanediol diglycidyl ether (meth)acrylate, cyclohexanedimethanol diglycidyl ether (meth)acrylate, 1,6-hexanediol diglycidyl ether (meth)acrylate, glycerin polyglycidyl ether (meth)acrylate, ethylene glycol diglycidyl ether (meth)acrylate, polyethylene glycol diglycidyl ether (meth)acrylate, dipropylene glycol diglycidyl ether (meth)acrylate, polypropylene glycol diglycidyl ether (meth)acrylate, 2-hydroxyethyl (meth)acrylate, 1-acryloyloxyethyl (meth)acrylate, 1,2,3-propanetriol 1,3-di(meth)acrylate, and 2-carboxyethyl (meth)acrylate.

Examples of the compound which gives the structural unit in the acrylic resin (a-IV) preferably include (meth)acrylic acid, 2-(meth)acryloyloxyethylsuccinic acid, 2-(meth)acryloyloxyethylphthalic acid, 2-(meth)acryloyloxyethyl-2-hydroxyethylphthalic acid, alkyl (meth)acrylates having 1 or more and 5 or less carbon atoms, polycycloalkyl (meth)acrylate (A-1), or aralkyl (meth)acrylate (A-2), in view of the effects of the invention. Examples of the (A-1) include a compound represented by any one of the above formulas (a-4-1c) to (a-4-1h) and having a single bond as R^{a21}, and examples of the (A-2) include benzyl (meth)acrylate.

In the acrylic resin (a-IV), the amount of the structural unit derived from the preferable compound is not particularly limited so long as the effects of the present invention are not inhibited, and is, for example, 10% by mass or more, and preferably 30% by mass or more based on the mass of the total structural units. The upper limit of the amount of the structural unit derived from the preferable compound may be selected appropriately, and for example, 100% by mass or less, and 90% by mass or less.

In addition, the acrylic resin (a-IV) may be a product obtained by polymerizing a monomer other than the (meth) acrylic acid ester. Examples of such a monomer include (meth)acrylamides, unsaturated carboxylic acids, allyl compounds, vinyl ethers, vinyl esters, styrenes, etc., and vinyl ethers or styrenes are preferable. These monomers may be used singly or in combination of two or more types thereof.

Examples of the (meth)acrylamides include (meth)acrylamide, N-alkyl(meth)acrylamide, N-aryl(meth)acrylamide, N,N-dialkyl(meth)acrylamide, N,N-aryl(meth)acrylamide, N-methyl-N-phenyl(meth)acrylamide, and N-hydroxyethyl-N-methyl(meth)acrylamide, etc.

Examples of the unsaturated carboxylic acids include monocarboxylic acids such as crotonic acid; dicarboxylic acids such as maleic acid, fumaric acid, citraconic acid, mesaconic acid, and itaconic acid; anhydrides of these dicarboxylic acids; etc.

Examples of the allyl compounds include allyl esters such as allyl acetate, allyl caproate, allyl caprylate, allyl laurate, allyl palmitate, allyl stearate, allyl benzoate, allyl acetoacetate, and allyl lactate; allyloxyethanol; etc.

Examples of the vinyl ethers include: alkyl vinyl ethers such as hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether, and tetrahydrofurfuryl vinyl ether; vinyl aryl ethers such as vinyl phenyl ether, vinyl tolyl ether, vinyl chlorophenyl ether, vinyl 2,4-dichlorophenyl ether, vinyl naphthyl ether, and vinyl anthranyl ether; etc.

Examples of the vinyl esters include vinyl butyrate, vinyl isobutyrate, vinyl trimethylacetate, vinyl diethylacetate, vinyl valerate, vinyl caproate, vinyl chloroacetate, vinyl dichloroacetate, vinyl methoxyacetate, vinyl butoxyacetate, vinyl phenylacetate, vinyl acetoacetate, vinyl lactate, vinyl β-phenylbutyrate, vinyl benzoate, vinyl salicylate, vinyl chlorobenzoate, vinyl tetrachlorobenzoate, vinyl naphthoate, etc.

Examples of the styrenes include: styrene; alkylstyrenes such as methylstyrene, dimethylstyrene, trimethylstyrene, ethylstyrene, diethylstyrene, isopropylstyrene, butylstyrene, hexylstyrene, cyclohexylstyrene, decylstyrene, benzylstyrene, chloromethylstyrene, trifluoromethylstyrene, ethoxymethylstyrene, and acetoxymethylstyrene; alkoxystyrenes such as methoxystyrene, 4-methoxy-3-methylstyrene, and dimethoxystyrene; halostyrenes such as chlorostyrene, dichlorostyrene, trichlorostyrene, tetrachlorostyrene, pentachlorostyrene, bromostyrene, dibromostyrene, iodostyrene, fluorostyrene, trifluorostyrene, 2-bromo-4-trifluoromethylstyrene, and 4-fluoro-3-trifluoromethylstyrene; etc.

Since the composition for metal oxide film formation according to the embodiment of the invention contains the metal oxide nanoparticles, the composition for metal oxide film formation can achieve the etching resistance necessary for the substrate processing even when the base material is the acrylic resin; however, a polymer including an aromatic ring, or a non-polymer including an aromatic ring, or both of them may be additionally employed as the base material from the viewpoint of an improvement in the etching resistance.

Examples of the non-polymer including an aromatic ring include a compound (X) having a bisphenylfluorene skeleton, a bisnaphthylfluorene skeleton, a methylenedinaphthalene skeleton, a tetrabenzonaphthalene skeleton, or a calix arene skeleton. The compound may have a substituent, and the substituent is preferably a polymerizable group, such as an acryloyl group, a methacryloyl group, a vinyloxy group, a styryl group, an allyl group, a propargyl group, a diglycidylamino group, and a dipropargylamino group, or an organic group including the polymerizable group, from the viewpoint of the curability of the composition for metal oxide film formation.

Examples of the polymer including an aromatic ring include:
resins having the skeleton constituting the compound (X), as a repeating structure;
resins having a benzene skeleton, a naphthalene skeleton, a biphenyl skeleton, and/or an anthracene skeleton as a repeating structure;
condensates of the compound (X).

The condensates are obtained by reacting the compound (X) with one or more selected from the group consisting of aldehydes, compounds having an alkoxy group, compounds having an alkanoyloxy group, trioxanes, and fluorenones. Alternatively, known novolac resins or the like may be employed as the polymer including an aromatic ring.

Novolac Resin (a-II)

Various novolac resins which have conventionally blended into photosensitive compositions may be employed as the novolac resin (a-II). The novolac resin (a-II) is preferably a resin which can be obtained by addition condensation of an aromatic compound having a phenolic hydroxyl group (hereinafter, also referred to simply as “phenol compound”) with an aldehyde in the presence of an acid catalyst.

Phenol Compound

Examples of the phenol compound to be used for the preparation of the novolac resin (a-II) include: phenol; cresols such as o-cresol, m-cresol, and p-cresol; xylenols such as 2,3-xylenol, 2,4-xylenol, 2,5-xylenol, 2,6-xylenol, 3,4-xylenol, and 3,5-xylenol; ethylphenols such as o-ethylphenol, m-ethylphenol, and p-ethylphenol; alkylphenols such as 2-isopropylphenol, 3-isopropylphenol, 4-isopropylphenol, o-butylphenol, m-butylphenol, p-butylphenol, and p-tert-butylphenol; trialkylphenols such as 2,3,5-trimethylphenol and 3,4,5-trimethylphenol; polyhydric phenols such as resorcinol, catechol, hydroquinone, hydroquinone monomethyl ether, pyrogallol, and phloroglucinol; alkylated polyhydric phenols (wherein any alkyl group has 1 or more and 4 or less carbon atoms) such as alkylresorcins, alkylcatechols, and alkylhydroquinones; α-naphthol; β-naphthol; hydroxydiphenyl; and bisphenol A; etc. These phenols may be used singly, or in combination of two or more types thereof.

Aldehyde

Examples of the aldehyde to be used for the preparation of the novolac resin (a-II) include formaldehyde, paraformaldehyde, furfural, benzaldehyde, nitrobenzaldehyde, acetaldehyde, etc. These aldehydes may be used singly, or in combination of two or more types thereof.

Acid Catalyst

Examples of the acid catalyst to be used for the preparation of the novolac resin (a-II) include: inorganic acids such as hydrochloric acid, sulfuric acid, nitric acid, phosphoric acid, and phosphorous acid; organic acids such as formic acid, oxalic acid, acetic acid, diethyl sulfate, and paratoluenesulfonic acid; and metal salts such as zinc acetate, etc. These acid catalysts may be used singly, or in combination of two or more types thereof.

The amount of the base material used is not particularly limited, and is, for example, 0.5 to 35% by mass, preferably 1 to 25% by mass, and more preferably 2 to 15% by mass based on the total mass of the components other than the solvent in the composition for metal oxide film formation. When the amount of the base material used is within the range described above, the ratio of the mass of the organic matter is not excessively high, and consequently the resultant metal oxide film is likely to be inhibited from volume shrinkage upon heating at a low temperature of 400° C. or lower.

In the solid content of the composition for metal oxide film formation, the ratio of the mass of the metal oxide nanoparticles to the total mass of the metal oxide nanoparticles and the base material is, for example, 45% by mass or more, preferably 50% by mass or more, more preferably 60% by mass or more, and even more preferably 65% by mass or more. The upper limit of the mass ratio is, for example, 95% by mass or less, and preferably 90% by mass or less.

Surfactant

The composition for metal oxide film formation according to the embodiment of the invention may further contain a surfactant (surface modifier) to improve, for example, the coating properties, antifoaming properties, and leveling properties of the composition. One type of the surfactant may be used alone, and a combination of two or more types of the surfactant may be used. Examples of the surfactant include silicone-based surfactants and fluorosurfactants.

Specific examples of the silicone-based surfactant include BYK-077, BYK-085, BYK-300, BYK-301, BYK-302, BYK-306, BYK-307, BYK-310, BYK-320, BYK-322, BYK-323, BYK-325, BYK-330, BYK-331, BYK-333, BYK-335, BYK-341, BYK-344, BYK-345, BYK-346, BYK-348, BYK-354, BYK-355, BYK-356, BYK-358, BYK-361, BYK-370, BYK-371, BYK-375, BYK-380, BYK-390 (manufactured by BYK Chemie), etc.

Specific examples of the fluorosurfactant include F-114, F-177, F-410, F-411, F-450, F-493, F-494, F-443, F-444, F-445, F-446, F-470, F-471, F-472SF, F-474, F-475, F-477, F-478, F-479, F-480SF, F-482, F-483, F-484, F-486, F-487, F-172D, MCF-350SF, TF-1025SF, TF-1117SF, TF-1026SF, TF-1128, TF-1127, TF-1129, TF-1126, TF-1130, TF-1116SF, TF-1131, TF-1132, TF-1027SF, TF-1441, and TF-1442 (manufactured by DIC); PF-636, PF-6320, PF-656, and PF-6520 in PolyFox series (manufactured by OMNOVA Solutions); etc.

The amount of the surfactant used is not particularly limited, and is, for example, 0.01 to 0.15% by mass, and preferably 0.05 to 0.1% by mass based on the total mass of the components other than the solvent in the composition for metal oxide film formation, from the viewpoint of the coating properties, antifoaming properties, leveling properties, etc. of the composition for metal oxide film formation.

Other Components

The composition for metal oxide film formation according to the embodiment of the invention may contain additives such as a dispersing agent, a thermal polymerization-inhibiting agent, an antifoaming agent, a silane coupling agent, a coloring agent (a pigment, a dye), an inorganic filler, an organic filler, a crosslinking agent, and an acid generating agent, as needed. For all of the additives described above, any conventionally known product may be used. The surfactant includes anionic, cationic, and nonionic compounds; the thermal polymerization-inhibiting agent includes hydroquinones, hydroquinone monoethyl ethers, etc.; and the antifoaming agent includes silicone-based, and fluorine-based compounds, etc.

Method for Producing Composition for Metal Oxide Film Formation

A method for producing the composition for metal oxide film formation according to the embodiment of the invention includes, for example, the step of: mixing a first dispersion containing the metal oxide nanoparticles, the capping agent, and the solvent with a polycarboxylic acid compound solution containing the polycarboxylic acid compound and the solvent, and the solvent (hereinafter, also referred to as “first mixing step”); or mixing a second dispersion containing the metal oxide nanoparticles, the polycarboxylic acid compound, and the solvent with the solvent (hereinafter, also referred to as “second mixing step”).

By way of example, in the first mixing step, the metal oxide nanoparticles are treated with the capping agent in the presence of the solvent, and then, to the resultant slurry, the polycarboxylic acid compound solution and the solvent, as well as the optional base material, the optional surfactant, and optional other components are added. By way of example, in the second mixing step, the metal oxide nanoparticles are treated with the polycarboxylic acid compound as the capping agent in the presence of the solvent, and then, to the resultant slurry, the solvent, as well as the optional base material, the optional surfactant, and optional other components are added. Specifically, the composition for metal oxide film formation according to the embodiment of the invention can be produced, for example, as shown in Examples described hereinbelow.

Method for Producing Metal Oxide Film

A method for producing a metal oxide film according to another embodiment of the invention includes the steps of: forming a coating film including the composition for metal oxide film formation according to the embodiment of the invention (hereinafter, also referred to as “coating film-forming step”); and heating the coating film (hereinafter, also referred to as “heating step”).

The coating film can be formed, for example, by applying the composition for metal oxide film formation to a substrate such as a semiconductor substrate. An exemplary application procedure includes the use of a contact transfer-type application device such as a roll coater, a reverse coater, or a bar coater, or a non-contact-type application device such as a spinner (rotary application device, spin coater), a dip coater, a spray coater, a slit coater, or a curtain flow coater. Alternatively, the viscosity of the composition for metal oxide film formation may be adjusted to an appropriate range, and then the composition for metal oxide film formation may be applied via a printing technique such as an ink-jet printing or screen printing to form a desirably patterned coating film. Among these, the use of the non-contact-type application device is preferable, and the use of the spinner is more preferable from the viewpoint that in such application devices, the composition for metal oxide film formation tends to adhere to an end face (edge) of the substrate, and/or go around the substrate to the back face thereof and adhere thereto, and hence the effects of the invention will be exerted more prominently.

The substrate preferably includes a metal film, a metal carbide film, a metal oxide film, a metal nitride film, or a metal oxynitride film. Examples of the metal constituting the substrate include silicon, titanium, tungsten, hafnium, zirconium, chromium, germanium, copper, aluminum, indium, gallium, arsenic, palladium, iron, tantalum, iridium, molybdenum, alloys thereof, or the like and the substrate preferably includes silicon, germanium, or gallium. Additionally, the surface of the substrate may have projections/depressions, and the projections/depressions may be due to a patterned organic-based material.

Preferably, the method for producing a metal oxide film according to the another embodiment of the invention further includes performing at least one of edge-rinsing or back-rinsing (hereinafter, also referred to as “washing step”). The washing step is performed, for example, between the coating film-forming step and the heating step. The procedure for the edge-rinsing and the back-rinsing may employ any conventionally known process without particular limitation. For example, the edge-rinsing includes applying a solvent along a peripheral portion of the substrate, and removing edge beads on the substrate. As the solvent for such edge-rinsing, a solvent for use in the composition for metal oxide film formation, and the like may be suitably used.

Then, volatile components such as the solvent are removed, if necessary, to dry the coating film. The drying procedure is not particularly limited, and, for example, includes drying on a hot plate at a temperature of 80° C. or higher and 140° C. or lower, preferably 90° C. or higher and 130° C. or lower for a time period of 60 sec or more and 150 sec or less. Drying under reduced pressure may be performed at room temperature using a vacuum dryer (VCD) prior to the heating on the hot plate.

After forming the coating film in this manner, the coating film is heated. The temperature in the heating is not particularly limited, and is preferably 400° C. or higher, more preferably 420° C. or higher, and even more preferably 430° C. or higher. The upper limit of the temperature may be appropriately selected, and may be, for example, 600° C. or lower, and is preferably 550° C. or lower from the viewpoint of the controllability of the etching rate in dry etching, or the intra-plane uniformity. Typically, the heating time is preferably 30 sec or more and 150 sec or less, and more preferably 60 sec or more and 120 sec or less. The heating step may be performed at a single heating temperature, or may include multiple stages of different heating temperatures.

The metal oxide film formed as described above is suitably utilized as a sacrificial film or a permanent film. The sacrificial film is, for example, a material for a metal hard mask or for a pattern reversal. The permanent film is, for example, a high dielectric constant film (high-k film).

### EXAMPLES

Hereinafter, the present invention will be described in more detail with reference to Examples, but the present invention is not in any way limited to these Examples.

Preparation of Composition for Metal Oxide Film Formation

The following dispersions were prepared with reference to paragraph [0223] of Japanese Unexamined Patent Application, Publication No. 2018-193481.

Preparation of Z-1 Dispersion

A slurry of ZrO₂ prepared according to the description in paragraph [0223] of Japanese Unexamined Patent Application, Publication No. 2018-193481 except that the molar ratio of water to zirconium(IV) isopropoxide isopropanol (Zr(OCH(CH₃)₂)₄(HOCH(CH₃)₂) to obtain the slurry of ZrO₂ was changed to 1:3 and cooled to room temperature was centrifuged to give a wet cake A. To the wet cake A was added 2-acryloyloxyethylsuccinic acid (see the formula below) in an amount 0.2 times as large as the weight of the wet cake A, and the mixture was stirred. After reprecipitation, centrifugation was performed to give a wet cake B. The wet cake B was dried overnight under reduced pressure, to give a powder. To the resultant dry powder was added propylene glycol monomethyl ether acetate (hereinafter, referred to as “PGMEA”) so as to achieve a solid content concentration of 48% by mass, and thus the dry powder was dispersed again. Then, this dispersion was filtered to give a Z-1 dispersion.

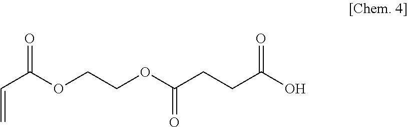

TG-DTA Measurement for Z-1 Dispersion

The Z-1 dispersion was placed on a platinum sample pan and subjected to TG-DTA measurement. The mass of a first residual solid which remained after heating the Z-1 dispersion from room temperature to 200° C. at a rate of 10° C./min and holding it at 200° C. for 5 min was designated as solid content mass. Next, the mass of a second residual solid which remained after heating the first residual solid from 200° C. to 710° C. at a rate of 10° C./min (without holding at 710° C.) was designated as the mass of inorganic matter. Using these measurements, the mass of organic matter was calculated according to the following formula: (mass of organic matter)=(solid content mass)−(mass inorganic matter), and the ratio of the mass of the inorganic matter to the sum of the mass of the inorganic matter and the mass of the organic matter (% by mass) was calculated according to the formula: (mass of inorganic matter)/(mass of inorganic matter+mass of organic matter). The mass of the organic matter for this case was 70% by mass. Further, the ratio of the mass of the organic matter to the sum of the mass of the inorganic matter and the mass of the organic matter (% by mass) was calculated according to the formula: (mass of organic matter)/(mass of inorganic matter+mass of organic matter). The ratio for this case was 30% by mass. It should be noted that the mass of the organic matter is derived from benzyl alcohol, which is used in the procedure described in paragraph [0223] of Japanese Unexamined Patent Application, Publication No. 2018-193481, and 2-acryloyloxyethylsuccinic acid described above. These correspond to a capping agent.

Measurement of Size of Metal Oxide Nanocluster Contained in Z-1 Dispersion

XRD measurement was performed on an X-ray diffractometer (SmartLab, manufactured by Rigaku Corporation) using the Z-1 dispersion as a sample. The results were analyzed by an accompanying software PDXL, and the size of the metal oxide nanocluster (crystallite size) was determined according to the Halder-Wagner method. The size of the metal oxide nanocluster for this case was 2.5 nm.

Preparation of Z-2 Dispersion

The same operations as in “Preparation of Z-1 Dispersion” described above were performed except that 2-acryloyloxyethylsuccinic acid was changed to spiculisporic acid (see the formula below) to give a Z-2 dispersion.

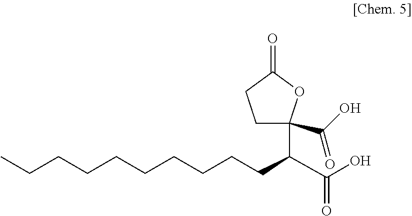 [SMILES: CCCCCCCCCC[C@H](C(=O)O)[C@]1(C(=O)O)CCC(=O)O1]

TG-DTA Measurement for Z-2 Dispersion

The same operations as in “TG-DTA Measurement for Z-1 Dispersion” described above were performed except that the Z-2 dispersion was used instead of the Z-1 dispersion. The ratio of the mass of the inorganic matter to the sum of the mass of the inorganic matter and the mass of the organic matter (% by mass) was calculated to be 70% by mass, and the ratio of the mass of the organic matter to the sum of the mass of the inorganic matter and the mass of the organic matter (% by mass) was calculated to be 30% by mass. It should be noted that the mass of the organic matter is derived from benzyl alcohol, which is used in the procedure described in paragraph [0223] of Japanese Unexamined Patent Application, Publication No. 2018-193481, and spiculisporic acid described above. These correspond to a capping agent.

Measurement of Size of Metal Oxide Nanocluster Contained in Z-2 Dispersion

The same operations as in “Measurement of Size of Metal Oxide Nanocluster Contained in Z-1 Dispersion” described above were performed except that the Z-2 dispersion was used instead of the Z-1 dispersion. The size of the metal oxide nanocluster (crystallite size) for this case was 2.5 nm.

Preparation of Z-3 Dispersion

The same operations as in “Preparation of Z-1 Dispersion” described above were performed except that the 2-acryloyloxyethylsuccinic acid was changed to 2-methacryloyloxyethylsuccinic acid (see the formula below) to give a Z-3 dispersion.

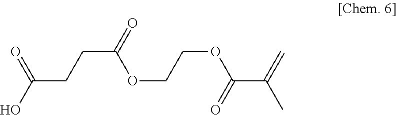 [SMILES: C=C(C)C(=O)OCCOC(=O)CCC(=O)O]

TG-DTA Measurement for Z-3 Dispersion

The same operations as in “TG-DTA Measurement for Z-1 Dispersion” described above were performed except that Z-3 dispersion was used instead of the Z-1 dispersion. The ratio of the mass of the inorganic matter to the sum of the mass of the inorganic matter and the mass of the organic matter (% by mass) was calculated to be 70% by mass, and the ratio of the mass of the organic matter to the sum of the mass of the inorganic matter and the mass of the organic matter (% by mass) was calculated to be 30% by mass. It should be noted that the mass of the organic matter is derived from benzyl alcohol, which is used in the procedure described in paragraph [0223] of Japanese Unexamined Patent Application, Publication No. 2018-193481, and 2-methacryloyloxyethylsuccinic acid described above. These correspond to a capping agent.

Measurement of Size of Metal Oxide Nanocluster Contained in Z-3 Dispersion

The same operations as in “Measurement of Size of Metal Oxide Nanocluster Contained in Z-1 Dispersion” described above were performed except that the Z-3 dispersion was used instead of the Z-1 dispersion. The size of the metal oxide nanocluster (crystallite size) for this case was 2.5 nm.

Preparation of Active Agent Solution 1

An active agent solution 1 was obtained by mixing 2 parts by mass of spiculisporic acid (manufactured by Iwata Chemical Co., Ltd.) and 98 parts by mass of PGMEA.

Preparation of Active Agent Solution 2

An active agent solution 2 was obtained by mixing 2 parts by mass of lauric acid (see the formula below) and 98 parts by mass of PGMEA.

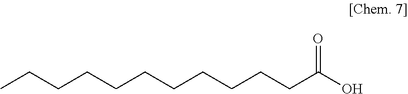

Preparation of Active Agent Solution 3

An active agent solution 3 was obtained by mixing 2 parts by mass of 2-octylsuccinic acid (see the formula below) and 98 parts by mass of PGMEA.

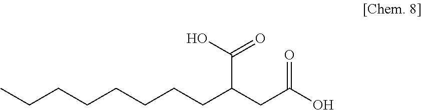 [SMILES: CCCCCCCCC(CC(=O)O)C(=O)O]

Preparation of Active Agent Solution 4

An active agent solution 4 was obtained by mixing 2 parts by mass of glutaric acid (see the formula below) and 98 parts by mass of PGMEA.

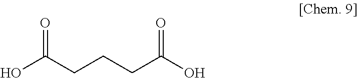

A composition was obtained by first adding the active agent solution to the Z-1 dispersion, Z-2 dispersion, or Z-3 dispersion at a ratio (unit:parts by mass) specified in Table 1, followed by the addition of a solvent PGMEA, stirring the mixture, and filtering it through a 0.2 μm Φ membrane filter. Incidentally, the numbers in parentheses in Table 1 represent the ratio of the solid content (unit:parts by mass).

Amount of Residual Metal after Washing (ICP-MS Measurement)

The composition was dropped onto an 8-inch silicon wafer, and the wafer was spun with an acceleration to 1,250 rpm in 2 sec, and then at 1,250 rpm for 30 sec to achieve spin coating. Immediately after the spin coating, rinsing was performed for 60 sec with a solvent PGMEA flowing from a central portion of the silicon wafer. The surface of the silicon wafer was treated with hydrogen fluoride to recover the total amount of residual Zr on the silicon wafer, and the measurement by ICP-MS was performed. The amount of the residual Zr (unit: ng) was determined, and the amount of the residual Zr was divided by the area of the silicon wafer to determine the amount of the residual metal (unit: atoms/cm²).

Ratio of Mass of Inorganic Matter

In Table 1, “ratio of mass of inorganic matter” means the ratio of the mass of the inorganic matter to the sum of the mass of the inorganic matter and the mass of the organic matter for the solid contents of the compositions. Specifically, the ratio (% by mass) of the mass of the inorganic matter of the Z-1 dispersion, Z-2 dispersion, or Z-3 dispersion to the sum of the solid content mass of the Z-1 dispersion, Z-2 dispersion, or Z-3 dispersion and the mass of each active agent in each active agent solution was calculated. The results are shown in Table 1.

TABLE 1

| | | | | | Comparative | Comparative | Comparative | Comparative |
|---|---|---|---|---|---|---|---|---|
| | Example 1 | Example 2 | Example 3 | Example 4 | Example 1 | Example 2 | Example 3 | Example 4 |
| Z-1 dispersion | 1.4 | | 1.4 | | 1.7 | 1.4 | 1.4 | |
| | (0.672) | | (0.672) | | (0.816) | (0.672) | (0.672) | |
| Z-2 dispersion | | 1.7 | | | | | | |
| | | (0.816) | | | | | | |
| Z-3 dispersion | | | | 1.4 | | | | 1.7 |
| | | | | (0.672) | | | | (0.816) |
| Active agent | 6.2 | | | | | | | |
| solution 1 | (0.124) | | | | | | | |
| Active agent | | | | | | 6.2 | 3.1 | |
| solution 2 | | | | | | (0.124) | (0.062) | |
| Active agent | | | 6.2 | 6.2 | | | | |
| solution 3 | | | (0.124) | (0.124) | | | | |
| Active agent | | | | | | | 3.1 | |
| solution 4 | | | | | | | (0.062) | |
| Solvent | 12.4 | 18.3 | 12.4 | 12.4 | 18.3 | 12.4 | 12.4 | 18.3 |
| Amount of residual | 2.30 × | 3.40 × | 1.80 × | 3.30 × | 2.80 × | 2.10 × | 3.50 × | 9.00 × |
| metal (atoms/cm²) | 10¹² | 10¹³ | 10¹³ | 10¹³ | 10¹⁵ | 10¹⁵ | 10¹⁵ | 10¹⁴ |
| Ratio of mass of | 59 | 70 | 59 | 59 | 70 | 59 | 59 | 70 |
| inorganic matter | | | | | | | | |
| (% by mass) | | | | | | | | |

As can be seen from Table 1, it has been demonstrated that the amount of the residual metal is decreased after washing in Examples, whereas the amount of the residual metal is decreased insufficiently in Comparative Examples.

What is claimed is:

1. A composition for metal oxide film formation, comprising metal oxide nanoparticles, a capping agent, a polycarboxylic acid compound, and a solvent, wherein
the polycarboxylic acid compound is comprised as the capping agent, or separate from the capping agent,
the metal oxide nanoparticles have a size of 5 nm or less,
the capping agent comprises at least one selected from the group consisting of an alkoxysilane, a phenol, an alcohol, a carboxylic acid, and a carboxylic acid halide,
at least one of molecular chain(s) linking any two carboxy groups in the polycarboxylic acid compound has a side chain optionally having a heteroatom, and the side chain has an alkyl group, and
in the solid content of the composition for metal oxide film formation, a ratio of a mass of inorganic matter to a sum of the mass of the inorganic matter and a mass of organic matter is 25% by mass or more.

2. The composition for metal oxide film formation according to claim 1, wherein a metal comprised in the metal oxide nanoparticles is at least one selected from the group consisting of zinc, yttrium, hafnium, zirconium, lanthanum, cerium, neodymium, gadolinium, holmium, lutetium, tantalum, titanium, silicon, aluminum, antimony, tin, indium, tungsten, copper, vanadium, chromium, niobium, molybdenum, ruthenium, rhodium, rhenium, iridium, germanium, gallium, thallium, scandium, and magnesium.

3. The composition for metal oxide film formation according to claim 1, wherein the polycarboxylic acid compound is succinic acid having a side chain, and the side chain optionally has a heteroatom and has an alkyl group.

4. The composition for metal oxide film formation according to claim 3, wherein the succinic acid is spiculisporic acid.

5. A method for producing the composition for metal oxide film formation according to claim 1, the method comprising:
mixing a first dispersion comprising the metal oxide nanoparticles, the capping agent, and the solvent with a polycarboxylic acid compound solution comprising the polycarboxylic acid compound and the solvent, and the solvent, or
mixing a second dispersion comprising the metal oxide nanoparticles, the polycarboxylic acid compound, and the solvent with the solvent.

6. A method for producing a metal oxide film, the method comprising:
forming a coating film comprising the composition for metal oxide film formation according to claim 1, and
heating the coating film.

7. The method for producing a metal oxide film according to claim 6, further comprising performing at least one of edge-rinsing or back-rinsing.

8. The method according to claim 6, wherein the metal oxide film is a sacrificial film or a permanent film.
